(19) United States
(12) Patent Application Publication
(10) Pub. No.: US 2024/0270611 A1
(43) Pub. Date: Aug. 15, 2024

(54) SYSTEM AND METHOD FOR REDOX-MEDIATED ELECTRODIALYSIS

(71) Applicants: The Board of Trustees of the University of Illinois, Urbana, IL (US); Kongju National University Industry-University Cooperation Foundation, Chungcheongnam-Do (KR)

(72) Inventors: Xiao SU, Champaign, IL (US); Nayeong KIM, Champaign, IL (US); Johannes ELBERT, Urbana, IL (US); Choonsoo KIM, Cheonan-si (KR)

(21) Appl. No.: 18/568,009

(22) PCT Filed: Jun. 30, 2022
(86) PCT No.: PCT/US22/35675

§ 371 Date: Dec. 7, 2023

Related U.S. Application Data
(60) Provisional application No. 63/217,292, filed on Jul. 1, 2021.

(51) Int. Cl. C02F 1/469; C02F 1/461; C02F 101/30

(52) U.S. Cl. CPC C02F 1/4693; C02F 2001/46133; C02F 2101/30; C02F 2201/46135; C02F 2201/4618

(57) ABSTRACT

A system for redox-mediated electrodialysis includes: a first electrode; a second electrode positioned in opposition to the first electrode; an anion exchange membrane and a cation exchange membrane positioned between the first and second electrodes; a feed channel for flow of a treating fluid, the feed channel extending between the anion and cation exchange membranes; an additional membrane or pair of membranes between the first and second electrodes, the additional membrane or pair of membranes defining a collection channel on one or both sides of the feed channel for collecting anions and cations removed from the treating fluid, the additional membrane or pair of membranes including an anion exchange membrane and/or a cation exchange membrane; and a redox channel for flow of a redox fluid, the redox channel containing the first and second electrodes and being separated from the feed and/or collection channels by the anion and/or cation exchange membranes.

### RELATED APPLICATION

The present patent document claims the benefit of priority to U.S. Provisional Patent Application No. 63/217,292, which was filed on Jul. 1, 2021, and is hereby incorporated by reference in its entirety.

### TECHNICAL FIELD

The present disclosure is related generally to a system and method for purification of fluids from biological, food and/or pharmaceutical manufacturing, and more specifically to redox-mediated electrodialysis.

### BACKGROUND

With the rapidly growing global population, sustainable food production is considered a key challenge to mitigate the closely coupled environmental and nutrition crises. As demand for dairy products increases, large volumes of whey are produced—a highly polluting byproduct from food manufacturing, with strict disposal regulations. During dairy production, large volumes of whey waste—considered one of the most polluting by-products in food manufacturing processes—are produced.

Studies have confirmed several positive effects of whey proteins for human health, such as an improvement of metabolism and a decrease in blood pressure. The benefits of these proteins extend from plant-based nutrition to even food texture and color control. Furthermore, lactose and its derivatives (4.5-5% of whey waste) have been commercialized in food and pharmaceutical industries. Therefore, whey waste could be a secondary nutrient source to meet the growing worldwide demand for food. However, highly concentrated salts in whey waste remain a major challenge for the valorization of whey proteins. Removing this highly concentrated salt content from the proteins is the cornerstone separation challenge in whey protein valorization. Several desalination technologies have been introduced to remove concentrated salts and recover proteins from whey waste, with various specific limitations. Although membrane technologies (e.g. reverse osmosis and nanofiltration) are widely used for whey desalination, they often require additional processes or chemical input for further separation between valuable contents and salts. Filtration technologies result in high energy consumption and operating cost for whey separation, due to the high pressure needed across a range of salt and whey concentrations. While ion-exchange can also be used for desalination, it requires a large volume of chemicals to regenerate the columns, thus leaving a significant solvent and chemical footprint. The development of a sustainable separation technologies for demineralizing the highly concentrated salts in whey waste may provide a pathway for the valorization of whey proteins from food processing waste, and for purification of other industrial fluid streams.

### BRIEF SUMMARY

A method for redox-mediated electrodialysis includes providing a system comprising: a first electrode; a second electrode positioned in opposition to the first electrode; an anion exchange membrane and a cation exchange membrane disposed between the first and second electrodes; a feed channel extending between the anion and cation exchange membranes; and a redox channel containing the first and second electrodes and being separated from the feed channel by the anion and cation exchange membranes. A redox solution comprising a redox couple is flowed through the redox channel, and a treating fluid comprising one or more biomolecules and an ionic species is flowed through the feed channel. The ionic species include anions and cations. A voltage is applied such that the first electrode becomes positively charged and the second electrode becomes negatively charged, and the redox couple undergoes oxidation near the first electrode and reduction near the second electrode. Consequently, the anions in the feed channel are drawn through the anion exchange membrane and the cations in the feed channel are drawn through the cation exchange membrane, while one or more biomolecules remain in the feed channel. Thus, the treating fluid is purified.

A system for redox-mediated electrodialysis includes: a first electrode; a second electrode positioned in opposition to the first electrode; an anion exchange membrane and a cation exchange membrane positioned between the first and second electrodes; a feed channel for flow of a treating fluid, the feed channel extending between the anion and cation exchange membranes; an additional membrane or pair of membranes between the first electrode and second electrodes, the additional membrane or pair of membranes including an anion exchange membrane and/or a cation exchange membrane, the additional membrane or pair of membranes defining a collection channel on one or both sides of the feed channel for collecting anions and cations removed from the treating fluid; and a redox channel for flow of a redox fluid, the redox channel containing the first and second electrodes and being separated from the feed and/or collection channels by the anion and/or cation exchange membranes.

### BRIEF DESCRIPTION OF THE DRAWINGS

FIG. 1 is a schematic of an exemplary redox-mediated electrodialysis system employed for purification of a treating fluid and biomolecule recovery.

FIG. 2 is a schematic of an exemplary redox-mediated electrodialysis system employed for the recovery of salt separated from the treating fluid during a prior purification step.

FIG. 3A is a schematic of the redox-mediated electrodialysis system modified to include an additional ion exchange membrane that defines a collection channel on one side of the feed channel, thereby allowing for simultaneous purification of the treating fluid and salt recovery.

FIG. 3B is a schematic of the redox-mediated electrodialysis system modified to include an additional pair of anion and cation exchange membranes that define collection channels on either side of the feed channel, thereby allowing for simultaneous purification of the treating fluid and salt recovery.

FIG. 4 is a schematic of the redox-mediated electrodialysis system modified to include multiple feed and collection channels.

FIG. 5 illustrates a net-zero waste process from manufacturing and generation of waste fluid through separation of large biomolecules (e.g., whey proteins) and subsequent or simultaneous salt recovery, followed by re-use of the salt in manufacturing.

FIG. 6 shows salt removal (%) as a function of operating time and voltage for an exemplary redox-mediated electrodialysis system; in the absence of a redox couple at 1 V, the salt removal is only 6%, while in the presence of the redox couple, the salt removal may reach up to 99%.

FIG. 7 shows the change in effluent pH and energy consumption at voltages from 0.4 V to 1.2 V after 99% salt removal, revealing that there are unnoticeable changes in effluent pH and energy consumption at various operating voltages.

FIG. 8 shows concentration and percent changes in whey protein of β-lactoglobulin (β-LG) after 99% salt removal.

FIG. 9 shows profiles of whey protein concentration as a function of operating time for voltages from 0.4 V to 1.2 V.

FIG. 10 shows circular dichroism spectra of β-LG before (dashed line), after treatment (99% salt removal at 1.2 V, dotted line), and after treatment with pH adjusted (solid line).

FIG. 11 shows the salt removal percentage for various pH levels of the whey solution (the treating solution) as a function of operating time.

FIG. 12 shows changes in pH and energy consumption after 99% salt removal for various pH levels of the whey solution.

FIG. 13 shows concentration and percent changes in whey protein of β-LG after 99% salt removal for various pH levels of the whey solution.

FIG. 14 shows salt removal percentage for various whey constituents, in particular, β-LG, α-lactalbumin (α-LA), and lactose, as a function of operating time.

FIG. 15 shows changes in pH and energy consumptions after 99% salt removal at representative valuable whey contents of β-LG, α-LA, and lactose.

FIG. 16 shows concentration and percent changes in whey protein of β-LG, α-LA, and lactose after 99% salt removal.

FIG. 17 shows profiles of effluent conductivity at different salt concentrations in the synthetic whey waste solution to remove the salt up to the potable water range.

FIG. 18 shows concentrations of β-LG and α-LA in various synthetic whey waste solutions, which were synthesized with 10 mM, 100 mM, and 500 mM NaCl to represent salt concentrations of acidic, sweet, and salty whey waste, respectively; the system demineralized up to 95% salt removal (0.5 mS/cm), which is within the potable water range and maintained the representative whey proteins (β-LG and α-LA) over 98%.

FIG. 19 shows percent of salt removal and releasing from long-term stability tests for 11 sequential protein purification and system regeneration processes.

FIG. 20 shows the concentration of β-LG and α-LA during the first and eleventh cycles of the long-term stability tests.

FIG. 21 is an exploded view of a lab-scale redox-mediated electrodialysis system.

### DETAILED DESCRIPTION

A redox-mediated electrodialysis system for the purification of fluids from bio, food, and pharmaceutical manufacturing processes is described in this disclosure. Reversible redox reactions are leveraged for the recovery of biomolecules (e.g., proteins, peptides, carboxylates) and concomitant removal of ionic species from fluids (“treating fluids”). More specifically, the oxidation or reduction of a redox couple in a redox channel of the system draws ionic species across ion-exchange membranes from a feed or treating channel, while non-charged or bulky molecules remain in the treating fluid. The redox couple maintains a balance between oxidized and reduced form by circulating through the redox channel, allowing steady salt removal over time. The ionic species removed from the treating fluid may be subsequently or simultaneously collected for re-use. The system and method may be applied to any fluid streams which require the separation of valuable contents (e.g., biomolecules or macromolecules) from ionic species.

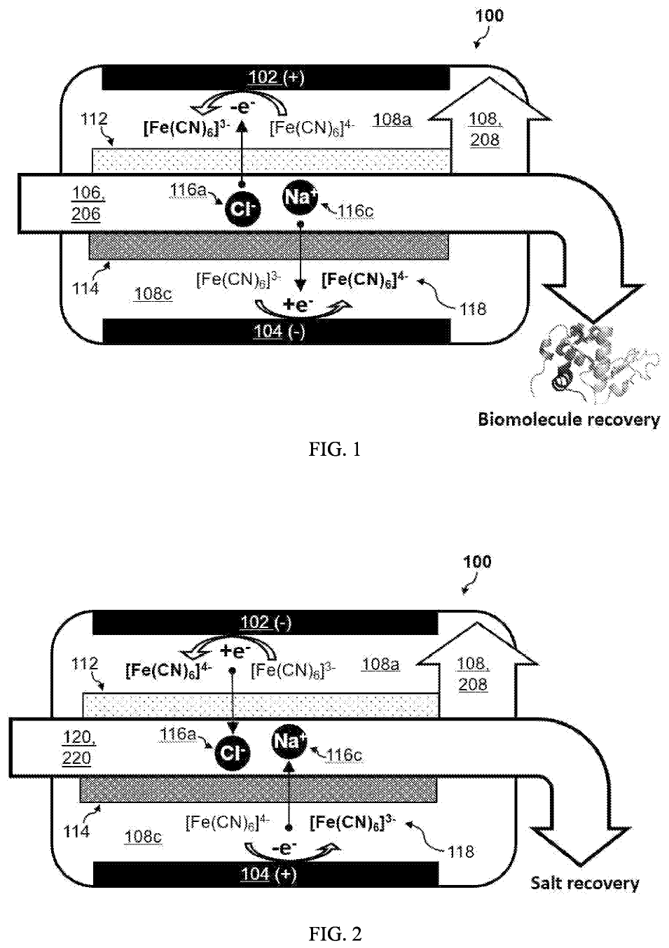

FIGS. 1 and 2 show an exemplary redox-mediated electrodialysis system where the feed channel, which is used for delivery of the treating fluid, may be used alternately as a salt collection channel after purification of the treating fluid. In other examples described below, the system may include both a feed channel and a salt collection channel for simultaneous purification of the treating fluid and collection of removed salt.

A method of purifying a treating fluid, which may be a waste stream from bio, food, or pharmaceutical manufacturing, is described in reference to FIG. 1. The method includes providing a system 100 including a first electrode 102, a second electrode 104 positioned in opposition to the first electrode, and an anion exchange membrane 112 and a cation exchange membrane 114 positioned between the first electrode 102 and the second electrode 104. The system 100 also includes a feed channel 106 that extends between the anion and cation exchange membranes 112,114, and a redox channel 108 that contains the first and second electrodes 102,104. The redox channel 108 has a first portion (or “anion portion”) 108a extending between the first electrode 102 and the anion exchange membrane 112, and a second portion (or “cation portion”) 108c extending between the second electrode 104 and the cation exchange membrane 114. The redox channel 108 is configured for continuous circulation of the redox fluid; for example, the redox channel may form a closed loop. The redox channel 108 is separated from the feed channel 106 by the anion and cation exchange membranes 112,114, and flow through the channels 106,108 is independently controllable. The system 100 may include a power supply connected to the first and second electrodes 102,104 for application of a suitable voltage.

The method includes flowing a redox solution 208 comprising a redox couple 118 through the redox channel 108, and flowing a treating fluid 206 including one or more biomolecules and an ionic species (e.g., a salt) through the feed channel 106. The flow rates of the treating fluid 206 and the redox solution 208 through the respective channels 106,108 may depend on factors such as the volume of each channel and the operating voltage. Pumps may be connected to the feed and redox channels 106,108 to control the flow rates. For the exemplary system shown in FIG. 1, flow rates in a range from about 0.5 mL/min to about 20 mL/min for the treating fluid 206 and the redox solution 208 may be suitable.

To effect purification, a voltage is applied such that the first electrode 102 takes on a positive charge (becomes a positive electrode) and the second electrode 104 takes on a negative charge (becomes a negative electrode). That is, a positive voltage is applied to the first electrode 102. The applied voltage catalyzes oxidization or reduction of the redox couple 118 in the redox channel 108. More particularly, the redox couple 118 undergoes oxidation near the first (positive) electrode 102, i.e., in the anion portion 108a of the redox channel 108, and reduction near the second (negative) electrode 104, i.e., in the cation portion 108c of the redox channel 108. The reaction is illustrated in FIG. 1 for the exemplary redox couple 118 of [Fe(CN)₆]³⁻ and [Fe(CN)₆]⁴⁻.

As a consequence of the redox reactions in the redox channel 108, anions (e.g., Cl⁻) 116a and cations (e.g., Na⁺) 116c from the ionic species in the treating fluid 206 pass through the anion and cation exchange membranes 112,114. That is, the anions 116a move through the anion exchange membrane 112 towards the positive electrode 102 and the cations 116c move through the cation exchange membrane 114 towards the negative electrode 104. In the system 100 shown in FIG. 1, the anions 116a enter the anion portion 108a of the redox channel 108, and the cations 116c enter the cation portion 108c of the redox channel 108. Since the redox channel 108 and the feed channel 106 are separated by the cation and anion exchange membranes 114,112, the redox couple 118 cannot pass over into the feed channel 106; similarly, due to their high molecular mass, the biomolecules in the feed channel 106 are excluded from the redox channel 108 by the ion exchange membranes. The redox couple 118 circulates through the redox channel 108, alternately undergoing oxidation near the first electrode 102 (in the anion portion 108a) and reduction near the second electrode 104 (in the cation portion 108c), allowing for continuous removal of the ions from the feed channel 106. Consequently, the ionic species (e.g., NaCl) is removed from the treating fluid 206, such that the treating fluid 206 is purified. The biomolecules remain in the treating fluid 206 and may be recovered, as illustrated in FIG. 1.

The one or more biomolecules in the treating fluid 106 may comprise a protein (e.g., whey protein, casein protein), peptide, carboxylate, organic acid, glycoside, carbohydrate, DNA, and/or RNA. The method has been demonstrated for beta-lactoglobulin, alpha-lactalbumin, but may be extended to any protein (e.g., bovine serum albumin, lactoferrin, and/or immunoglobulin), organic acid (e.g., lactic, acetic, and/or succinic acid), and/or other biomolecules as indicated above. Purification of a whey waste solution to recover whey proteins is described in examples below.

The redox couple is dissolved in the redox fluid as an electrolyte. No additional electrolyte is required. The redox couple may comprise V²⁺/V³⁺, VO²⁻/VO₂⁺, Zn/Zn²⁺, Fe²⁺/Fe³⁺, [Fe(CN)₆]⁴⁻/[Fe(CN)₆]³⁻, a quinone derivative, a 2,2,6,6-tetramethylpiperidine-1-oxyl (TEMPO) derivative, and/or a ferrocene derivative. Typically, the redox fluid comprises water. Alternatively, the redox fluid may comprise an organic solvent, such as acetone, methanol, ethanol, benzene, toluene, and/or an ionic liquid. In such examples, the redox couple may comprise [Fe(bpy)₃]²⁺/[Fe(bpy)₃]³⁺, CoCp₂/CoCp₂⁺, ferrocene/ferrocenium, and/or V(acac)₃/[V(acac)₃]⁺. The reversible redox species (that is, the redox couple) may be selected for particular valorization or purification processes. The redox channel may include the redox couple at a relatively low concentration that may depend on the size of the electrodes and the volume of the redox channel. In one example, the concentration of the redox couple may be in a range from about 5 mM to about 500 mM, e.g., for a pair of electrodes having an area up to about 16 cm².

The voltage applied to catalyze the redox reactions is less than the voltage required for the water-splitting reaction (greater than 1.2 V) used in conventional electrodialysis, where water is split into hydroxide ions and protons. For example, the voltage applied in redox-mediated electrodialysis may be less than 1.2 V, or less than 1 V, and as low as 0.4 V as shown here, or possibly as low as 0.1 V in some examples. Experiments described below evaluated salt removal at various operating voltages, and it was found that a higher operating voltage (e.g., greater than 0.6 V) may be effective to reduce the time required to achieve nearly complete (99%) salt removal without any noticeable protein denaturation and/or deformation. As demonstrated below, energy consumption may be maintained at less than 100 kJ/mol_{NaCl}, more specifically at around 95 kJ/mol_{NaCl} (2.50 kWh/m³) or less, while achieving purification of the treating fluid.

Using the exemplary system 100 shown in FIG. 1, the ionic species removed from the treating fluid 106 may be collected in a subsequent regeneration process. The regeneration process may commence after sufficient purification of the treating fluid 206 (e.g., after at least about 95% salt removal, or at least about 99% salt removal), at which time the flow of the treating fluid 206 through the feed channel 106 and/or the positive applied voltage may be halted. Referring now to FIG. 2, to effect regeneration, a collection fluid (e.g., water) 220 may be flowed through the feed channel 106, which may be described now as a collection channel 120. In the regeneration process shown in FIG. 2, the collection fluid 220 and the collection channel 120 replace the treating fluid 206 and the feed channel 106 in the purification process. Also, the applied voltage is reversed such that the first electrode 102 takes on a negative charge (becomes a negative electrode) and the second electrode 104 takes on a positive charge (becomes a positive electrode). In other words, a positive voltage is applied to the second electrode 104. The applied voltage catalyzes oxidization or reduction of the redox species 118 in the redox channel 108. More particularly, the redox couple 118 undergoes reduction in the first portion (or anion portion) 108a of the redox channel 108 and oxidation in the second portion (or cation portion) 108c of the redox channel 108, as illustrated in FIG. 2 for the exemplary redox couple 118 comprising [Fe(CN)₆]³⁻ and [Fe(CN)₆]⁴⁻.

As a consequence of the redox reactions in the redox channel 108, anions (e.g., Cl⁻) 116a and cations (e.g., Na⁺) 116c that had previously been removed from the treating fluid 206 are effectively pushed out of the redox channel 108 and into the collection channel 120, where they may re-form the ionic species (e.g., NaCl) in the collection fluid 220. That is, the anions 116a move through the anion exchange membrane 112 and into the collection channel 120, and the cations 116c move through the cation exchange membrane 114 and into the collection channel 120. Accordingly, the salt that was removed from the treating fluid 206 can be recovered and reused, as illustrated in FIG. 2.

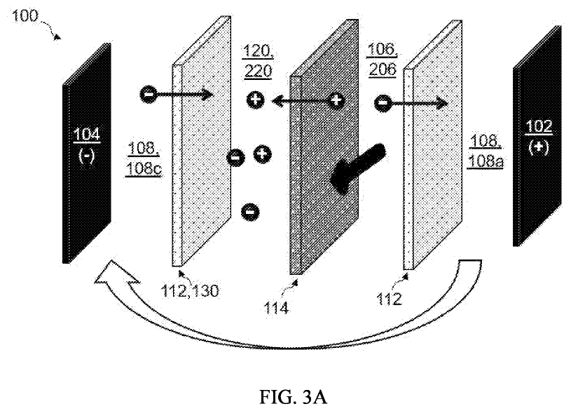

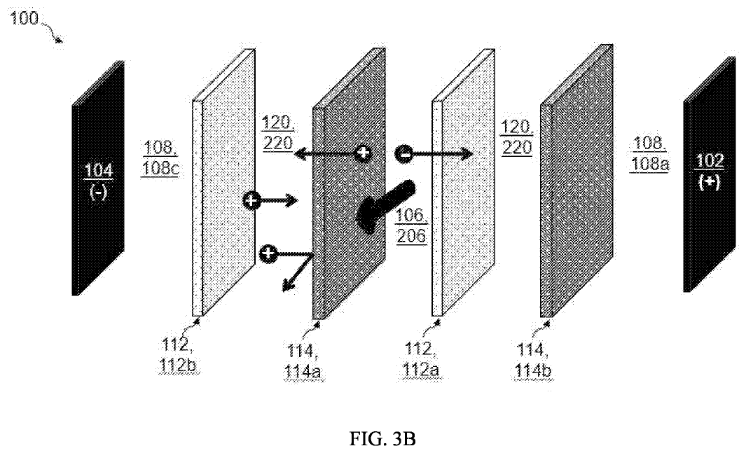

In order to simultaneously purify the treating fluid 206 and collect the removed salt, the system 100 shown in FIG. 1 may be modified to include an additional anion or cation exchange membrane 112,114 or an additional pair of the anion and cation exchange membranes 112,114 between the first and second electrodes 102,104. The additional membrane or pair of membranes define collection channels 120 on one or both sides of the feed channel 106, as illustrated in FIGS. 3A and 3B. The anion and cation exchange membranes 112,114 are alternately arranged between the first and second electrodes 102,104.

Referring first to FIG. 3A, the system 100 may include the first electrode 102, the second electrode 104 positioned in opposition to the first electrode 102, an anion exchange membrane 112 and a cation exchange membrane 114 disposed between the first and second electrodes 102,104, and the feed channel 106 extending between the first pair of membranes for delivery of the treating fluid 206. As indicated above, an additional membrane 130, which may be an anion exchange membrane 112 or a cation exchange membrane 114, defines a collection channel 120 on one side of the feed channel 106. The system 100 also includes the redox channel 108 which contains the first and second electrodes 102,104, and which is separated from the collection channel 120 and the feed channel 106 by two of the anion and cation exchange membranes 112,114. More specifically, in this exemplary configuration, the portion 108a of the redox channel 108 near the first electrode 102 is separated from the feed channel 106 by the anion exchange membrane 112, and the portion 108c of the redox channel 108 near the second electrode 104 is separated from the collection channel 120 by the (additional) anion exchange membrane 112,130.

A voltage may be applied as described above while the redox solution 208 is flowed through the redox channel 108 and the treating fluid 206 is flowed through the feed channel 106. In addition, a collection fluid 220 (e.g., water) is flowed through the collection channel 120. One or more pumps may be connected to the feed, redox, and collection channels 106,108,120 to control the flow rate of the fluids 206,208,220 through the channels 106,108,120. When the voltage is applied, redox reactions occur, and the anions and cations in the treating fluid 206 are drawn through the anion and cation exchange membranes 112,114 as described above. However, in this exemplary system 100, after passing through the anion and cation exchange membranes 112,114 from the treating fluid, the anions and cations enter the collection fluid 220. Since, in this example, the additional membrane 130 is an anion exchange membrane 112, the anions pass through the redox channel 108 prior to entering the collection channel 120. As in the previous example, the redox couple circulates through the redox channel 108, alternately undergoing oxidation near the first electrode 102 (in the anion portion 108a) and reduction near the second electrode 104 (in the cation portion 108c), allowing for continuous removal of the ionic species from the feed channel 106 and into the collection channels 120. Consequently, simultaneous purification of the treating fluid 206 and collection of the removed salts may be achieved.

Referring now to FIG. 3B, the system 100 includes the first electrode 102, the second electrode 104 positioned in opposition to the first electrode 102, an anion exchange membrane 112 and a cation exchange membrane 114 disposed between the first and second electrodes 102,104, and the feed channel 106 extending between the anion and cation exchange membranes 112,114 for delivery of the treating fluid 206. The anion and cation exchange membranes 112,114 may be described as first anion and first cation exchange membranes 112a,114a, where, in this example, an additional pair of membranes define collection channels 120 on either side (both sides) of the feed channel 106. The additional pair of membranes include a second cation exchange membrane 114b positioned between the first electrode 102 and the first anion exchange membrane 112a and a second anion exchange membrane 112b positioned between the second electrode 104 and the first cation exchange membrane 114a. The system 100 also includes the redox channel 108 which contains the first and second electrodes 102,104, and which is separated from the collection channels 120 by the additional pair of membranes. More specifically, the portion 108a of the redox channel 108 near the first electrode 102 is separated from the collection channel 120 by the second cation exchange membrane 114b, and the portion 108c of the redox channel 108 near the second electrode 104 is separated from the collection channel 102 by the second anion exchange membrane 112b.

A voltage may be applied as described above while the redox solution 208 is flowed through the redox channel 108 and the treating fluid 206 is flowed through the feed channel 106. In addition, a collection fluid 220 is flowed through the collection channels 120. One or more pumps may be connected to the feed, redox, and collection channels 106,108,120 to control the flow rate of the collection fluid 220 through the channels 106,108,120. When the voltage is applied, redox reactions occur, and the anions and cations in the treating fluid 206 are drawn through the anion and cation exchange membranes 112,114 as described above. In this example, after passing through the anion and cation exchange membranes 112,114 from the treating fluid, the anions and cations directly enter the collection fluid 220 in the collection channels 120. Due to the location of the second anion exchange membrane 112b adjacent to the second electrode 104 and the second cation exchange membrane 112a adjacent to the first electrode 102 in the configuration of FIG. 3B, anions and cations collected in the collection channels 120 tend not to enter the redox channel 108. Consequently, the redox channel 108 may include an electrolyte in addition to the redox couple. As above, the redox couple circulates through the redox channel 108, alternately undergoing oxidation near the first electrode 102 (in the anion portion 108a) and reduction near the second electrode 104 (in the cation portion 108c), allowing for continuous removal of the ionic species from the feed channel 106 and into the collection channels 120. The collection channels 120 shown in FIG. 3B may constitute portions of a salt collection channel where the cations and anions may be recombined. For example, the collection channels 120 may merge into a single salt collection channel downstream of the collection channels 120, or the collection channels 120 may be portions of a closed loop salt collection channel. Consequently, simultaneous purification of the treating fluid 206 and collection of the removed salts may be achieved.

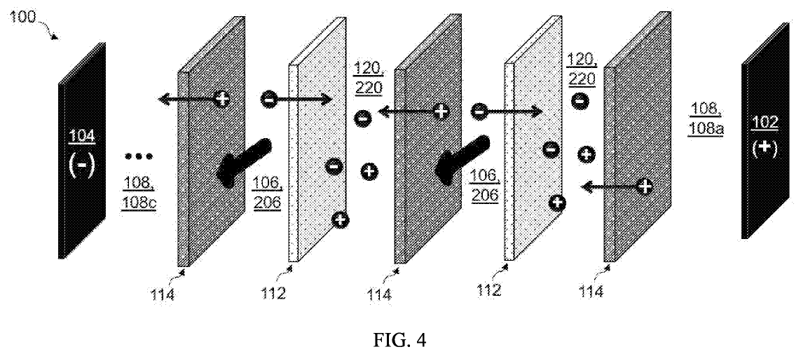

As shown in FIG. 4, the system 100 may include multiple anion and cation exchange membranes 112,114, such as five in this example, so as to include multiple (e.g., two) feed channels 106 and multiple (e.g., two) collection channels 120. Generally speaking, the system may include up to n of the anion and cation exchange membranes 112,114, where n is an integer equal to 2 or higher, preferably an odd integer equal to 3 or higher, such as 5, 15 or 25. Accordingly, in some examples, the system 100 may contain up to (n−1)/2 collection channels 120, and up to (n−1)/2 feed channels 106. The anion and cation exchange membranes 112,114 may be obtained from any of a number of commercial sources. Cation exchange membranes 112 typically comprise a polymer film including negatively-charged functional groups, while anion exchange membranes 114 typically comprise a polymer film including positively-charged functional groups.

It is also contemplated that the system 100 may include a stack of two or more of the first electrodes 102 and a stack of two or more of the second electrodes 104, allowing for higher voltages to be achieved without significantly increasing the size of the system 100. Suitable first and second electrodes 102,104 for the system 100 may be carbon-based or made of another electrically conductive material.

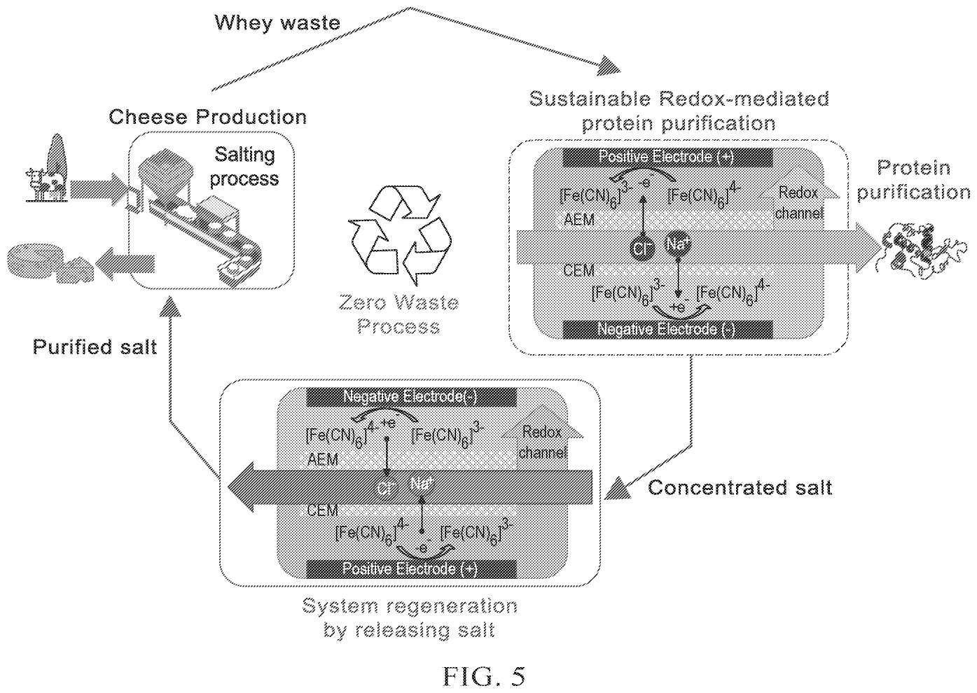

In a particular example described below, a sustainable redox-mediated electrodialysis system 100 as illustrated in FIGS. 1 and 2 is applied to the desalination of whey waste and salt concentration for reuse, as well as the simultaneous recovery of protein contents. This work marks the first time a reversible redox reaction has been exploited for food manufacturing and waste revalorization. The system 100 utilizes a reversible redox reaction at a lower operation voltage than the water-splitting reaction employed in electrodialysis, as indicated above, thereby enabling an energy-efficient operation without requiring acidification of the whey solution, which is known to cause aggregation of whey proteins. Furthermore, the redox-mediated electrodialysis system allows recovery of ionic species (e.g., NaCl) during a system regeneration step, as described above. Consequently, the system may not only facilitate reuse of the removed salts and redox-involved electrolyte, but also dramatically decrease the environmental impact of dairy production, paving the way to a net-zero waste process of secondary resources in the food industry, as shown schematically in FIG. 5. As described below, desalination performance is investigated at various operating parameters and whey conditions, including operating voltages, pH levels, and salt concentrations, to validate the system feasibility for protein purification from whey waste. Moving towards process sustainability, net-zero waste is demonstrated in a lab-scale version of the system 100 over multiple cycles.

The redox-mediated electrodialysis system 100 employed in this example includes two independently controllable channels—a feed channel 106 for the whey waste (the feed solution 206) and a redox channel 108 for the electrodes 102,104—separated by a pair of anion and cation exchange membranes 112,114, as illustrated in FIG. 1. A reversible redox couple 118 of ferricyanide [Fe(CN)₆]³⁻ and ferrocyanide [Fe(CN)₆]⁴⁻ in the redox channel 108 allows for continuous demineralization via its reversible redox reaction. In the redox-mediated electrodialysis system 100, applying ferri-/ferrocyanide allows continuous desalination below the potable water range, 100 μS/cm, without any additional process. During purification of a treating fluid 206, positive ions 116c such as Na⁺ move from the feed channel 106 to the redox channel 108 when ferrocyanide is oxidized to ferricyanide at the positive electrode 102, while negative ions 116a such as Cl⁻ move to the redox channel 108 when ferricyanide is reduced back to ferrocyanide at the negative electrode 104, resulting in a sustainable regeneration of the redox couple 118. By releasing the removed ions 116a,116c to the feed channel 106, as illustrated in FIG. 2, the redox channel 108 can maintain its concentration, and recovered NaCl can be reused (e.g., in cheese production), suggesting a net-zero waste process.

### Investigation of Protein Purification Performance at Various Operating Voltages

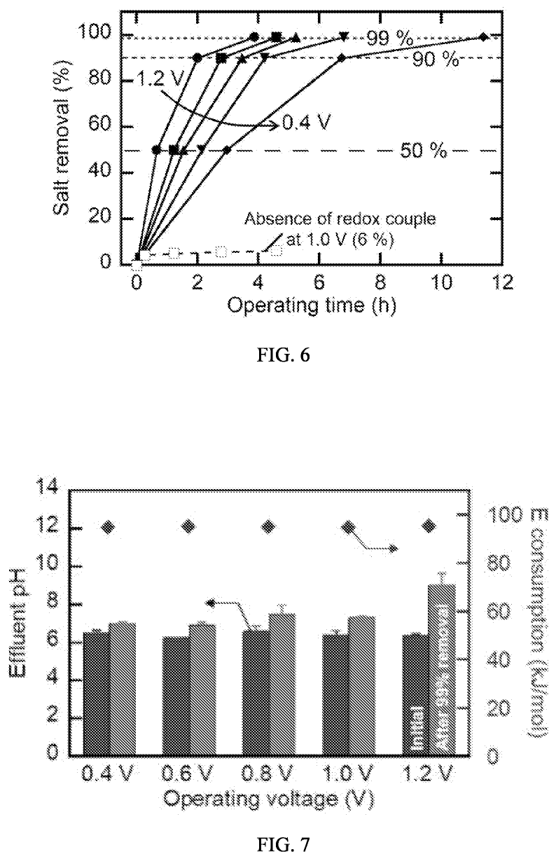

Referring to FIG. 6, the performance of protein purification from whey waste was evaluated at the operating voltage range from 0.4 to 1.2 V. The redox-mediated electrodialysis system successfully demineralized 99% of salt from the whey solution within a single step. Considering there is 6% salt removal in the absence of the redox couple at 1.0 V, demineralization up to 99% can be largely attributed to the continuous redox reaction between ferri- and ferrocyanide. Notably, the time required for protein purification may depend on the operating voltage. For instance, 99% of the salt removal took only 4 hours at the operating voltage of 1.2 V, while requiring more than 11 hours at the operating voltage of 0.4 V. The use of two (or more) ion-exchange membranes and two (or more) independent channels may increase the resistance, requiring a higher operating voltage to fully trigger the redox reaction. Therefore, a sufficiently high operating voltage (e.g., over 0.6 V) may be required to reach 99% salt removal with effective utilization of the redox couple in the redox channel.

Moreover, several operational features such as desalination rate and pH changes were also analyzed. The rate of desalination (slope of FIG. 6; unit of %/h) was 17-66%/h up to 50% salt removal and then significantly decreased to 2-5%/h for 90-99% salt removal. The nonlinear salt removal rate may be attributed to the increased solution resistance from the feed channel. Electrochemical impedance spectroscopy demonstrated that the solution resistance of the system increased over 56 times after 99% salt removal due to the low ionic concentration in the feed channel, resulting in a much slower salt removal rate. In this regard, applying conductive resins in the feed channel may allow a consistent desalination rate over the purification process by maintaining the ionic concentration in the feed channel. Considering the increase in the effluent pH at the voltage between 0.4 and 1.0 V as shown in FIG. 7, it is postulated that the system was operated with the presence of minor side reactions, such as the production of hydrogen peroxide. At most, the effluent pH changed from 6.4 to 9.0 at the operating voltage of 1.2 V. Along with the pH change, a relatively high current flow at 1.2 V suggests the presence of a side reaction. Based on the pH change in the feed channel and the electron balance, the charge used for the water-splitting reaction is calculated to be less than 0.01%. Regardless of the presence of side reactions, this calculation demonstrates that protein purification or desalination (e.g., 99% salt removal) can be largely attributed to the continuous redox reaction. As shown in FIG. 7, the energy consumption was maintained at around 95 kJ/mol_{NaCl} (2.50 kWh/m³). Assuming the side reaction is mostly the water-splitting reaction, it might also promote the salt removal from the feed channel with an analogous mechanism to the conventional electrodialysis system. Consequently, the charge efficiency was close to unity over the investigated range of the operating voltages, indicating that the applied charge was extensively used for protein purification.

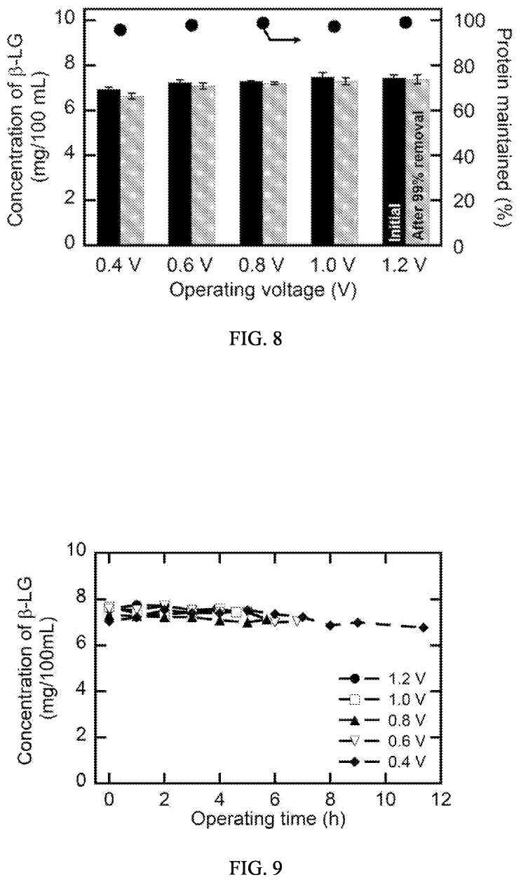

Furthermore, FIGS. 8 and 9 highlight that the representative whey protein, β-LG, was retained in the feed channel throughout the desalination with an average of 2% loss, possibly due to adhesion to the membranes or tubes (feed channel wall). Referring to Table 1 below, undetected protein in the redox channel also provides evidence that the protein is excluded by the ion exchange membranes due to its high molecular mass. In addition, undetected iron concentration in the feed channel confirms that the redox couple does not contaminate the whey protein in the feed solution.

TABLE 1
The concentration of Fe from the effluent in the feed channel
and concentration of β-LG in the redox channel after 99%
salt removal from the feed solution.

| Operating | Concentration of Fe | Concentration of β-LG |
|---|---|---|
| voltage (V) | in the feed channel | in the redox channel |
| 0.4 | Not detected (ND) | ND |
| 0.6 | ND | ND |
| 0.8 | ND | ND |
| 1.0 | ND | ND |
| 1.2 | ND | ND |

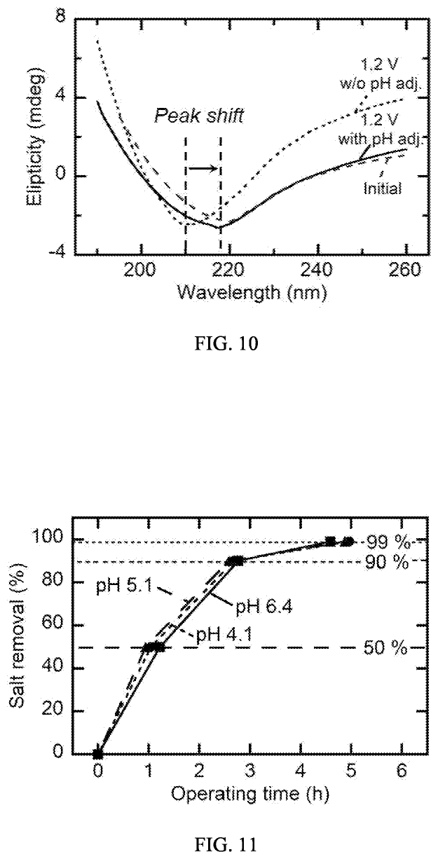

To confirm the stability and conformational change of the purified protein, circular dichroism (CD) spectra were measured. Insignificant changes in the CD spectra were observed over the range of 0.4-1.0 V. The spectrum of β-LG after the operation at 1.2 V was shifted to the left because the pH increase changed the conformational distribution between α-helix and β-sheet. However, the protein was not denatured permanently, proved by adjusting the pH back to its starting value, as shown in FIG. 10; rather, as the pH increased, the protein might become a deprotonated form. Considering desalination performance as well as the whey protein condition, 1.0 V may be the optimal operating voltage, at least in this lab-scale system, and is employed for the rest of the experiments.

### Investigation of Protein Purification Performance at Various Whey Conditions

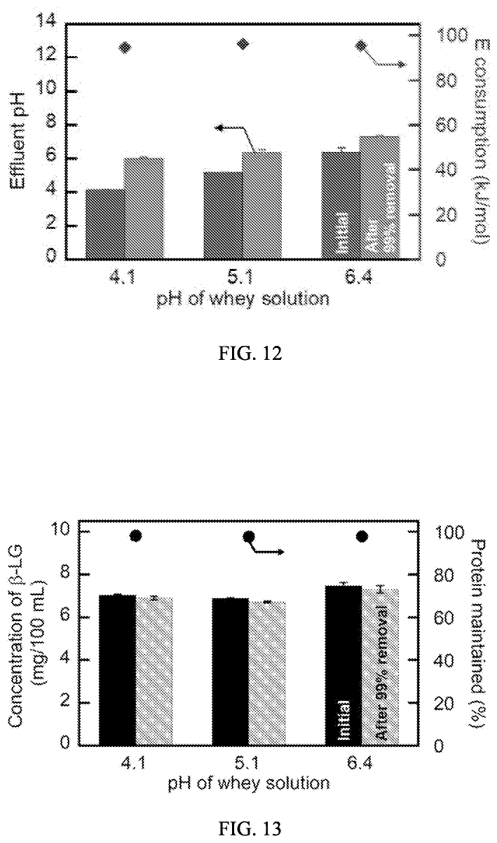

Referring to FIGS. 11-13, the effective protein purification at various whey solution pH implies that the redox-mediated electrodialysis system could compatibly treat various whey solutions such as acidic, sweet, and salty whey wastes. The desalination rates were independent of the feed pH condition, as shown in FIG. 11, with the average energy consumption of 95 kJ/mol_{NaCl} (2.61 kWh/m³), as shown in FIG. 12. Besides, 98% of β-LG was preserved over the experiments, as shown in FIG. 13. The effluent pH after 99% of salt removal slightly increased to around pH 6 and pH 7.3, but the protein maintained its stability. In fact, the increase in pH from acidic to neutral can help to reduce the probability of aggregation or denaturation of whey proteins. At the isoelectric point, the net charge of a protein goes to zero, which significantly reduces the repulsive electrostatic forces between protein molecules, resulting in the aggregation and denaturation of proteins. Considering the isoelectric points of major whey protein contents (e.g., β-LG and α-LA around 4.2-5.2), a minor increase of pH to neutral would effectively avoid precipitation and degradation, which was recognized as a major limitation of conventional electrodialysis systems. Given that the majority of acid whey, which contains as much protein as sweet whey, is still discarded due to its low pH, pH control by electrochemistry may extend the application of acid whey.

TABLE 2
Components of acid, sweet and salty whey, and whey proteins.

| | | Sweet | | | |
|---|---|---|---|---|---|
| | Acid | whey | Salty | Whey | |
| Component | whey (%) | (%) | whey (%) | protein | % |
| Water | 94-95 | 90-95 | 86-92 | β-LG | 50-55 |
| Salts | 0.5-0.7 | 0.2 | 2.5-6.9 | α-LA | 20-28 |
| (mM | (17-31 mM) | (35 mM) | (400-1,000 | | |
| NaCl) | | | mM) | | |
| Proteins | 0.8-1 | 0.6-1 | 0.8 | Lactoferrin | 7-15 |
| Total | 5-6.4 | 6-8 | 9-12 | IgG | 3-7 |
| solids | | | | | |
| Fat | 0.003-0.38 | 0.2-0.5 | 0.6-0.8 | BSA | 2-3 |

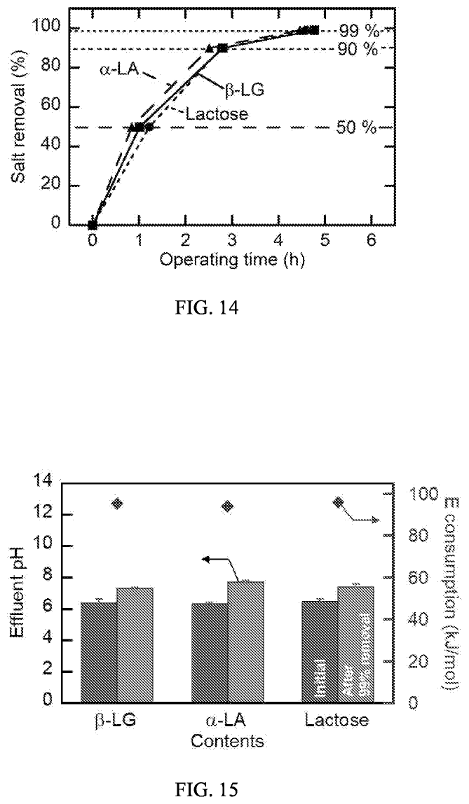

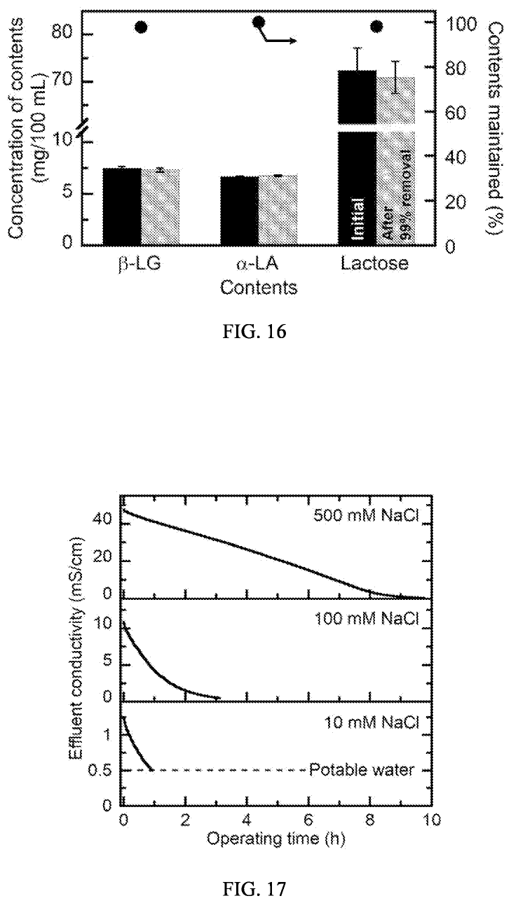

Moreover, the system successfully purified each of the valuable whey contents (constituents) such as β-LG, α-LA, and lactose respectively. Note that β-LG and α-LA are the two major protein contents in the whey waste (70-80% of total protein content as shown in Table 2) while whey waste usually contains 4.5-5% lactose. The results of FIGS. 14 and 15 show that within an average of 4.6 hours, the system can achieve 99% salt removal with an energy consumption around 94-96 kJ/mol_{NaCl} (2.59-2.63 kWh/m³). The experiments were performed with 100 mM NaCl and representative whey waste contents such as 7 ppm of β-LG and α-LA and 70 ppm of lactose as the treating fluid, while 100 mM NaCl with 50 mM ferri- and ferrocyanide was used as a redox electrolyte. The system was operated until 99% salt removal with flow rates of 5 mL/min for both channels at the operating voltage of 1.0 V. An insignificant increase of pH from 6.3-6.5 to 7.3-7.7 was observed with >98% contents maintained, as shown in FIG. 16. Since the size of valuable whey proteins and whey contents is considerably larger than Na⁺ and Cl⁻, they cannot cross-over the ion exchange membranes. In the future, by taking advantage of the characteristic molecular size and isoelectric point of each whey content, the system has the potential to valorize whey wastes by further separating protein contents between themselves. For instance, molecular selectivity may be achieved by tuning the membrane pore size, incorporating selective protein adsorbents, or leveraging controllable affinity in metallopolymer electrodes.

### Whey Valorization in a Net-Zero Waste Process

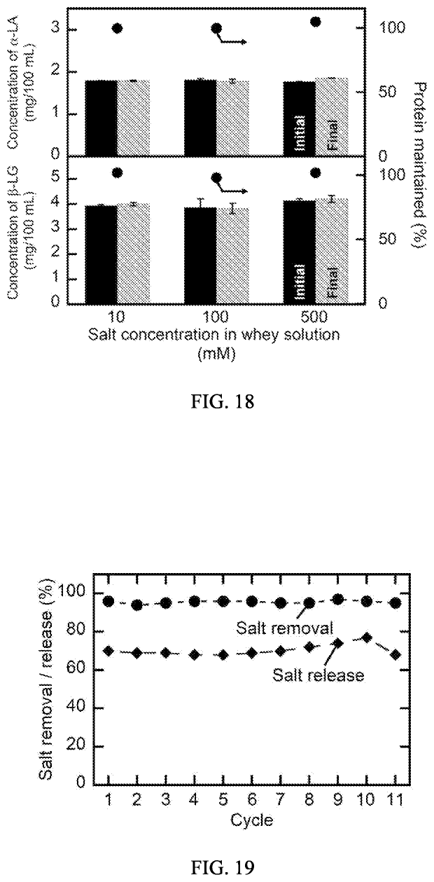

The redox-mediated electrodialysis system exhibited remarkable desalination performance in whey waste solutions, from 10 mM NaCl (simulating acidic whey waste) to 500 mM NaCl (simulating salty whey waste). Referring to FIG. 17, the operating time to desalinate to a potable water range varied based on the salt concentrations from 0.92 h for 10 mM to 9.76 h for 500 mM NaCl. Besides, the overall desalination rate was dependent on the feed concentration. By reducing the systematic resistance, faster desalination was achieved as the feed concentration increased (10 mM/h, 22 mM/h, and 52 mM/h for 10 mM, 100 mM, and 500 mM, respectively). Importantly, analysis of the two major proteins in the whey powder (β-LG and α-LA) indicated that over 98% of whey proteins were preserved in various synthetic conditions, as shown in FIG. 18. Because of the osmotic effect, the protein concentrations increased by 2-5% in the synthetic salty whey solution (500 mM NaCl). A high salt concentration gradient between the redox and feed channels can result in the diffusion of water from the feed due to high osmotic pressure, increasing the protein concentrations. This implies that the system condition might need to be adjusted depending on the conditions of the treated whey. For instance, the system could reduce the osmotic effect by simply using a lower salt concentration or a larger volume of the redox channel with comparable desalination performance.

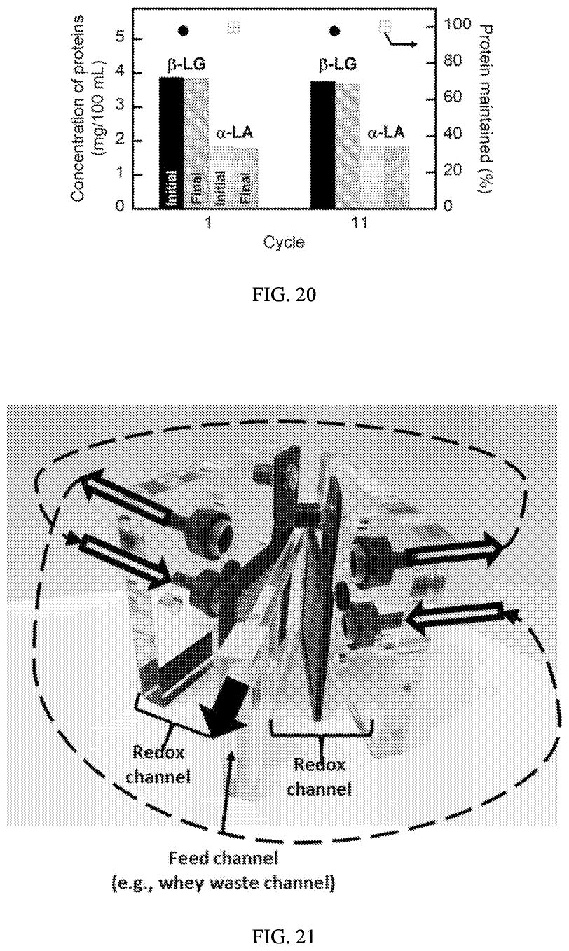

With a view towards a fully sustainable and circular process, the redox-mediated electrodialysis system can be designed as a net-zero waste process for waste valorization, as depicted in FIG. 5. Subsequent to the protein purification process, the removed salt was released in the feed channel to test the feasibility of recycling whey salts for the salting process in cheese production. Releasing concentrated salts from the redox channel also allows for the sustainable use of the redox couple, by maintaining a high concentration of the electrolyte. Therefore, recycling the removed salt may not only be cost-effective but may also allow sustainable system operation. Cyclability testing was conducted over 11 cycles between salt removal (1.0 V) and releasing processes (−1.0 V). As a lab-scale proof of concept, judicious voltages and time for 95% salt removal and 70% salt recovery were selected. The results confirmed a steady protein purification performance over 11 cycles, as shown in FIGS. 19 and 20. Notably, 98% and 100% of β-LG and α-LA were preserved at the 11^{th} protein purification process. As demonstrated, the system can be feasible in cyclable operation, both for the valorization of the whey protein and the recovery of the separated salts.

### Experimental Details

### Materials

All chemicals were obtained from Sigma Aldrich, VWR, Fisher Scientific or TCI, and used as received.

### Cell Assembly

The exemplary redox-mediated electrodialysis system employed for the above-described experiments includes a redox channel (4×4×0.2 m³), a whey waste channel (feed channel, 4×4×0.5 m³), and cation and anion exchange membranes (CMVN and AMVN, Selemion, Japan). In the redox channel, activated carbon cloths (CH900-20, Kuraray, Japan) having a size of 4×4 cm² were used as electrodes. As shown in FIG. 1, the feed channel is placed in between the redox channel, and both channels were separated by a pair of ion exchange membranes (5×5 cm²). FIG. 21 shows an exploded view of the lab-scale system. In the redox channel, 100 mL of 50 mM K₃Fe(CN)₆ and 50 mM Na₄Fe(CN)₆·10H₂O with 100 mM NaCl (Sigma-Aldrich, USA) was used as an electrolyte for all experiments. Ferricyanide and ferrocyanide are employed as the redox couple due to their high reversibility and rate capability. The system or cell was assembled in order of the anodic side of the redox channel, an anion exchange membrane, the feed channel, the cation exchange membrane, and the cathodic side of the redox channel. Then, using a peristaltic pump (Langer Instruments Co., USA), flow rates were set to 5 mL/min for both channels.

### Analysis of Desalination Performance

The desalination performance was analyzed at various operating conditions: operating voltages (0.4-1.2 V), pH of whey solution (pH 4.1-6.4), whey contents (β-LG, α-LA, and lactose), and salt concentration (10-500 mM). In common, the concentration of salt in the feed channel was simultaneously analyzed by a conductivity meter (Horiba, Japan) while the initial and final pH were measured with a pH meter (Horiba, Japan). The system was operated in a two-electrode system at a constant applied voltage using a potentiostat (Admiral Instruments, USA). For various operating voltages (0.4-1.2V), 30 mL of 100 mM NaCl with 7 ppm β-LG was desalinated. To adjust the pH of the whey solution, 1-10 mM HCl was used. To investigate desalination performance with representative whey contents, whey solution was prepared with 100 mM NaCl and whey contents (7 ppm β-LG, 7 ppm β-LG, or 70 ppm lactose). Finally, synthetic whey waste was made using commercial whey powder (7 ppm) and various salt concentrations (10, 100, and 500 mM NaCl). The sequential protein purification and the regeneration processes were conducted with the reverse-operation voltage mode (1.0 V and −1.0 V for the protein purification and the regeneration steps, respectively). Then, with 30 mL of 100 mM NaCl, the cyclability of the system was investigated for the first 10 cycles. For the final cycle (11^{th} cycle), 30 mL of 100 mM NaCl with 7 ppm whey powder was replenished in the feed channel to analyze the protein purification and recovery performance. The desalination performance was evaluated with electrochemical metrics such as charge efficiency and energy consumption. The charge efficiency was calculated by equation (1):

$$Charge efficiency = {n}_{NaCl} / ( \frac{\int 1 d}{F} ) \qquad ( 1 )$$

where n_{NaCl} is desalinated salt (mole), F is the Faraday constant (96,485 C/mol), and/is the current (A).

The energy consumption per mole of salt removed was evaluated using equation (2):

$$Energy consumption ( J / mol ) = \frac{v}{{n}_{NaCl}} \int Idt \qquad ( 2 )$$

where V is the applied voltage (V).

### Electrochemical Analysis

Cyclic voltammetry was conducted to investigate the peak potential and the reversibility of the ferricyanide and ferrocyanide at various scan rates (1-100 mV/s). A three-electrode system was used with Pt wires as working and counter electrodes and Ag/AgCl (3M KCl) as a reference electrode. Then 5 mL of 100 mM NaCl and 100 mM sodium ferrocyanide was used as the electrolyte. To investigate the faradaic reactivity, peak current was analyzed with respect to the square root of scan rate.

Electrochemical impedance spectroscopy (EIS) was measured to calculate the solution resistances at various operating voltages over the desalination test. The EIS of the redox-mediated electrodialysis system was analyzed at various operating voltages (0.4-1.2 V) with an amplitude of 50 mV in the frequency range of 0.01-10,000 Hz at the initial and in the frequency range of 0.1-10,000 Hz after 99% salt removal. The solution resistance value was calculated based on an equivalent circuit of R(Q(RW))(QR) with ZsimpWin (AMETEK, Inc., USA).

### Analysis of Various Whey Contents (β-LG, α-LA, and Lactose)

The concentrations of β-LG and α-LA in the feed and redox channels were measured by using reversed-phase high-performance liquid chromatography (RP-HPLC) (Agilent 1260 Infinity II, Agilent Technologies, USA). Using the C₃ column (75 mm×2.1 mm×5 μm, Agilent POROSHELL 300SB), one can detect both β-LG and α-LA separately with gradient elution between two solvents: Phase A, 0.1% (V/V) trifluoroacetic acid (TFA) in DI water and Phase B, 0.1% TFA in acetonitrile. The elution gradient with respect to phase A was set as follows: 0-5 min, 70-45%; 5-10 min, 45-40%; 10-12 min, 40-70%; 12-16 min, 70%. The sample volume of 40 μL was injected with a flow rate of 1.0 mL/min and the column temperature at 50° C. The injection sample was prepared after a 1:5 dilution of samples with phase A. The injection volume was 40 μL after 1:5 dilution with Phase A. The concentrations were determined from the absorbance at a wavelength of 280 nm for β-LG and 215 nm for α-LA. Since β-LG and α-LA are two major whey proteins (70-80% of whey proteins in whey waste), we analyzed the protein recovery (%) based on changes in both concentrations.

The CD spectra of β-LG were measured over the wavelength range of 190-260 nm by using a circular dichroism spectrometer (Cary-16, OLIS, USA). A quartz cuvette with 1 mm of path length and 190-2500 nm of wavelength range (Azota Co., USA) was used as a sample holder and the temperature of the sample chamber was maintained at 20° C. by a temperature controller (TC 125, Quantum Northwest, USA). The concentrations of lactose were determined by using a UV-vis spectrophotometer (Cary 60, Agilent Technologies, USA) after the post-treatment with EnzyChrom™ Lactose Assay Kit (BioAssay Systems, USA). During the post-treatment, enzyme-coupled reactions cleaved lactose into galactose which of the calibration was made at 570 nm.

The subject-matter of the disclosure may also relate to the following aspects:

A first aspect relates to a method for redox-mediated electrodialysis, the method comprising: providing a system including: a first electrode; a second electrode positioned in opposition to the first electrode; an anion exchange membrane and a cation exchange membrane disposed between the first and second electrodes; a feed channel extending between the anion and cation exchange membranes; and a redox channel containing the first and second electrodes and being separated from the feed channel by the anion and cation exchange membranes; flowing a redox solution comprising a redox couple through the redox channel; flowing a treating fluid comprising one or more biomolecules and an ionic species through the feed channel, the ionic species including anions and cations; applying a voltage, the first electrode becoming positively charged and the second electrode becoming negatively charged, the redox couple undergoing oxidation near the first electrode and reduction near the second electrode, whereby the anions in the feed channel are drawn through the anion exchange membrane and the cations in the feed channel are drawn through cation exchange membrane, while the one or more biomolecules remain in the feed channel, thereby purifying the treating fluid.

A second aspect relates to the method of the first aspect, wherein the one or more biomolecules comprise a protein, peptide, carboxylate, organic acid, glycoside, carbohydrate, DNA, and/or RNA.

A third aspect relates to the method of the first or second aspect, wherein the protein comprises a whey protein.

A fourth aspect relates to the method of any preceding aspect, wherein the redox fluid includes water.

A fifth aspect relates to the method of any preceding aspect, wherein the redox couple is selected from the group consisting of: V²⁺/V³⁺, VO²⁻/VO₂⁺, Zn/Zn²⁺, Fe²⁺/Fe³⁺, [Fe(CN)₆]⁴⁻/[Fe(CN)₆]³⁻, Quinone derivatives, TEMPO derivatives, and ferrocene derivatives.

A sixth aspect relates to the method of any preceding aspect, wherein the redox fluid includes an organic solvent.

A seventh aspect relates to the method of any preceding aspect, wherein the redox couple is selected from the group consisting of: [Fe(bpy)3]²⁻/[Fe(bpy)3]³⁺, CoCp²/CoCp²⁺, ferrocene/ferrocenium, and V(acac)₃/[V(acac)₃]⁺.

An eighth aspect relates to the method of any preceding aspect, wherein the redox couple is dissolved in the redox fluid.

A ninth aspect relates to the method of any preceding aspect, wherein the redox channel includes the redox couple at a concentration in a range from about 30 mM to about 100 mM.

A tenth aspect relates to the method of any preceding aspect, wherein the voltage is 1.2 V or less.

An eleventh aspect relates to the method of the tenth aspect, wherein the voltage is in a range from 0.4 V to 1.2 V.

A twelfth aspect relates to the method of any preceding aspect, wherein purifying the treating fluid comprises removing at least about 95% of the ionic species from the treating fluid.

A thirteenth aspect relates to the method of the twelfth aspect, wherein at least about 99% of the ionic species is removed from the treating fluid.

A fourteenth aspect relates to the method of any preceding aspect, wherein purifying the treating fluid consumes less than 100 kJ/mol_{NaCl}.

A fifteenth aspect relates to the method of any preceding aspect, wherein the treating fluid is a waste stream from bio, food or pharmaceutical manufacturing.

A sixteenth aspect relates to the method of any preceding aspect, wherein a flow rate of the treating fluid through the feed channel and/or a flow rate of the redox solution through the redox channel is in a range from about 1 mL/min to about 10 mL/min.

A seventeenth aspect relates to the method of any preceding aspect, wherein the redox couple circulates through the redox channel during the application of the voltage, the oxidation near the first electrode and the reduction near the second electrode occurring repetitively.

An eighteenth aspect relates to the method of any preceding aspect, further comprising, after purifying the treating fluid: flowing a collection fluid through the feed channel; and reversing the voltage, the first electrode becoming negatively charged and the second electrode becoming positively charged, the redox couple undergoing oxidation near the second electrode and reduction near the first electrode, whereby the anions and cations previously removed from the treating fluid are drawn through the anion and cation exchange membranes and into the collection fluid, the feed channel thereby functioning as a collection channel for the ionic species.

A nineteenth aspect relates to the method of any preceding aspect, wherein the system further comprises an additional membrane or pair of membranes between the first and second electrodes, the additional membrane or pair of membranes including an anion exchange membrane and/or a cation exchange membrane, wherein the additional membrane or pair of membranes define collection channels on one or both side of the feed channel for collecting the anions and cations drawn through the anion and cation exchange membranes as the treating fluid is purified.

A twentieth aspect relates to the method of the nineteenth aspect, wherein the collection channels are portions of a salt collection channel where the anions and cations recombine.

A twenty-first aspect relates to the method of the nineteenth or twentieth aspects, wherein the system includes up to n of the anion and cation exchange membranes alternately positioned between the first and second electrodes, preferably an odd integer.

A twenty-second aspect relates to the method of any preceding aspect, wherein the system includes a stack of two or more of the first electrodes and a stack of two or more of the second electrodes.

A twenty-third aspect relates to a system for redox-mediated electrodialysis, the system comprising: a first electrode; a second electrode positioned in opposition to the first electrode; an anion exchange membrane and a cation exchange membrane positioned between the first and second electrodes; a feed channel for flow of a treating fluid, the feed channel extending between the anion and cation exchange membranes; an additional membrane or pair of membranes between the first electrode and second electrodes, the additional membrane or pair of membranes defining a collection channel on one or both sides of the feed channel for collecting anions and cations removed from the treating fluid, the additional membrane or pair of membranes including an anion exchange membrane and/or a cation exchange membrane; and a redox channel for flow of a redox fluid, the redox channel containing the first and second electrodes and being separated from the feed and/or the collection channels by two of the anion and cation exchange membranes.

A twenty-fourth aspect relates to the system of the twenty-third aspect, wherein the collection channels constitute portions of a salt collection channel for recombination of the anions and cations removed from the treating fluid.

A twenty-fifth aspect relates to the system of the twenty-third or twenty-fourth aspect, including up to n of the anion and cation exchange membranes alternately positioned between the first and second electrodes, n being an integer, preferably an odd integer.

A twenty-sixth aspect relates to the system of any of the twenty-third through the twenty-fifth aspects, further comprising a stack of two or more of the first electrodes and a stack of two or more of the second electrodes, each stack including two or more of the first or second electrodes.

A twenty-seventh aspect relates to the system of any of the twenty-third through the twenty-sixth aspects, wherein the redox channel is configured for continuous circulation of the redox fluid.

A twenty-eighth aspect relates to the system of any of the twenty-third through the twenty-seventh aspects, further comprising a power supply connected to the first and second electrodes.

A twenty-ninth aspect relates to the system of any of the twenty-third through the twenty-eighth aspects, further comprising one or more pumps connected to the feed, redox, and/or collection channels.

A thirtieth aspect relates to the system of any of the twenty-third through the twenty-ninth aspects, wherein the first and second electrodes comprise carbon.

A thirty-first aspect relates to the system of any of the twenty-third through the thirtieth aspects, wherein each of the anion exchange membranes comprises a polymer film including positively-charged functional groups, and wherein each of the cation exchange membranes comprises a polymer film including negatively-charged functional groups.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A method for redox-mediated electrodialysis, the method comprising:
providing a system including:
a first electrode;
a second electrode positioned in opposition to the first electrode;
an anion exchange membrane and a cation exchange membrane disposed between the first and second electrodes;
a feed channel extending between the anion and cation exchange membranes; and
a redox channel containing the first and second electrodes and being separated from the feed channel by the anion and cation exchange membranes;
flowing a redox solution comprising a redox couple through the redox channel;
flowing a treating fluid comprising one or more biomolecules and an ionic species through the feed channel, the ionic species including anions and cations;
applying a voltage, the first electrode becoming positively charged and the second electrode becoming negatively charged, the redox couple undergoing oxidation near the first electrode and reduction near the second electrode,
whereby the anions in the feed channel are drawn through the anion exchange membrane and the cations in the feed channel are drawn through cation exchange membrane, while the one or more biomolecules remain in the feed channel, thereby purifying the treating fluid.

2. The method of claim 1, wherein the one or more biomolecules comprise a protein, peptide, carboxylate, organic acid, glycoside, carbohydrate, DNA, and/or RNA.

3. The method of claim 2, wherein the protein comprises a whey protein.

4. (canceled)

5. The method of claim 1, wherein the redox couple is selected from the group consisting of: V²⁺/V³⁺, VO²⁻/VO₂⁺, Zn/Zn²⁺, Fe²⁺/Fe³⁺, [Fe(CN)₆]⁴⁻/[Fe(CN)₆]³⁻, Quinone derivatives, TEMPO derivatives, and ferrocene derivatives.

6. The method of claim 1, wherein the redox fluid includes an organic solvent.

7. The method of claim 1, wherein the redox redox couple is selected from the group consisting of: [Fe(bpy)₃]²⁺/[Fe(bpy)₃]³⁺, CoCp₂/CoCp₂⁺, ferrocene/ferrocenium, and V(acac)₃/[V(acac)₃]⁺.

8. (canceled)

9. The method of claim 1, wherein the redox channel includes the redox couple at a concentration in a range from about 30 mM to about 100 mM.

10. The method of claim 1, wherein the voltage is 1.2 V or less.

11. (canceled)

12. The method of claim 1, wherein purifying the treating fluid comprises removing at least about 95% of the ionic species from the treating fluid.

13-14. (canceled)

15. The method of claim 1, wherein the treating fluid is a waste stream from bio, food or pharmaceutical manufacturing.

16-17. (canceled)

18. The method of claim 1, further comprising, after purifying the treating fluid:
flowing a collection fluid through the feed channel; and
reversing the voltage, the first electrode becoming negatively charged and the second electrode becoming positively charged, the redox couple undergoing oxidation near the second electrode and reduction near the first electrode,
whereby the anions and cations previously removed from the treating fluid are drawn through the anion and cation exchange membranes and into the collection fluid, the feed channel thereby functioning as a collection channel for the ionic species.

19-22. (canceled)

23. A system for redox-mediated electrodialysis, the system comprising:
a first electrode;
a second electrode positioned in opposition to the first electrode;
an anion exchange membrane and a cation exchange membrane positioned between the first and second electrodes;
a feed channel for flow of a treating fluid, the feed channel extending between the anion and cation exchange membranes;
an additional membrane or pair of membranes between the first electrode and second electrodes, the additional membrane or pair of membranes defining a collection channel on one or both sides of the feed channel for collecting anions and cations removed from the treating fluid, the additional membrane or pair of membranes including an anion exchange membrane and/or a cation exchange membrane; and
a redox channel for flow of a redox fluid, the redox channel containing the first and second electrodes and being separated from the feed and/or collection channels by two of the anion and cation exchange membranes.

24. The system of claim 23, wherein the collection channels constitute portions of a salt collection channel for recombination of the anions and cations removed from the treating fluid.

25. The system of claim 23, including up to n of the anion and cation exchange membranes alternately positioned between the first and second electrodes, n being an integer, preferably an odd integer.

26. The system of claim 23, further comprising a stack of two or more of the first electrodes and a stack of two or more of the second electrodes, each stack including two or more of the first or second electrodes.

27. The system of claim 23, wherein the redox channel is configured for continuous circulation of the redox fluid.

28. (canceled)

29. The system of claim 23, further comprising one or more pumps connected to the feed, redox, and/or collection channels.

30. The system of claim 23, wherein the first and second electrodes comprise carbon.

31. The system of claim 23, wherein each of the anion exchange membranes comprises a polymer film including positively-charged functional groups, and
wherein each of the cation exchange membranes comprises a polymer film including negatively-charged functional groups.
